(19) United States
(12) Patent Application Publication
(10) Pub. No.: US 2015/0273540 A1
(43) Pub. Date: Oct. 1, 2015

(54) CLEANING SOLUTION OBTAINED BY RECYCLING A SPENT SOLUTION

(71) Applicants: ELODYS INTERNATIONAL, Avrille (FR); UNIVERSITE DE BRETAGNE SUD, Lorient (FR); BARRAULT RECHERCHE, Avrille (FR); EAU ET INDUSTRIE, Plumeliau (FR)

(72) Inventors: Mathias Welschbillig, Plumeliau (FR); Mehdi Dif, Lamballe (FR); Walid Blel, Saint Nazaire (FR)

(21) Appl. No.: 14/436,080

(22) PCT Filed: Oct. 14, 2013
(86) PCT No.: PCT/FR2013/000268

§ 371 Date: Apr. 15, 2015

(30) Foreign Application Priority Data
Oct. 15, 2012 (FR) 12/02745

(51) Int. Cl. B08B 9/027; C11D 7/06; C11D 11/00; B01D 15/00; B01D 17/00

(52) U.S. Cl. CPC B08B 9/027; B01D 15/00; B01D 17/00; C11D 11/0041; C11D 7/06; C02F 2103/327

(57) ABSTRACT

A cleaning solution obtained from an aqueous solution of alkaline or acid pH which has undergone at least two cleaning and recycling cycles. Each cleaning and recycling cycle includes the successive steps of heating a solution of alkaline or acid pH to a temperature above 50° C., completely cleaning the pipework of equipment fouled with organic deposits using the heated solution, and bringing the solution obtained after the cleaning steps into contact with a clay of at least one of the families selected from smectites, sepiolites, vermiculites and illites. At least one one anionic or cationic flocculating agent is added, followed by precipitation and separation to recover said aqueous solution.

### RELATED APPLICATIONS

This application is a §371 application from PCT/FR2013/000268 filed Oct. 14, 2013, which claims priority from French Patent Application No. 12 02745 filed Oct. 15, 2012, each of which is herein incorporated by reference in its entirety.

### TECHNICAL FIELD OF THE INVENTION

The present invention relates to cleaning solutions prepared from spent solutions; it also relates to a cleaning process using such cleaning solutions.

### BACKGROUND OF THE INVENTION

The recycling of solutions, for instance the recycling of effluents used in the context of cleaning in place (also denoted as the abbreviation CIP), is known. In this context, the objective is to clean, in particular, food equipment without contaminating it, and therefore to have recourse to methods which do not have any impact on consumer health and, in addition, are not harmful to the environment.

U.S. Pat. No. 5,510,037 shows the recycling of neutral, acid or basic solutions using clays, such as bentonites, and flocculants, for recycling washing solutions after the use thereof in the treatment of the pipework of food equipment, for instance dairy equipment. This recycling implements absorption, coagulation, flocculation, precipitation and then filtration steps.

Application WO 2010/063906 describes the use of sodium bentonite activated with calcium carbonate, which makes it possible to dispense with the combined use of two flocculants. Indeed, such an activation makes it possible to use just one anionic or cationic flocculant, and also improves sludge precipitation.

There is a strong wish, in particular in the food-processing industry, to make use of, for cleaning and disinfecting the piping of industrial equipment, activation of the species present in the medium of cleaning solutions, and to dispense with the use of chemical products usually considered to be barely compatible with the hygiene standards in force in the food-processing field.

### OBJECT AND SUMMARY OF THE INVENTION

In this context, the present invention aims to provide a detergent and disinfectant solution which is obtained simply and which has no impact on the environment. This solution must also make it possible to avoid the use of additional chemical agents while at the same time demonstrating an improvement in its detergent and/or disinfectant activity compared with the solutions known in the CIP field.

According to a first aspect, the present invention relates to a cleaning solution which can be obtained from an aqueous solution of alkaline or acid pH which has undergone at least two cleaning and recycling cycles, each cleaning and recycling cycle comprising the successive steps of:
heating a solution of alkaline or acid pH to a temperature above 50° C.;
completely cleaning the pipework of equipment fouled with organic deposits using said heated solution;
bringing the solution obtained after the cleaning steps into contact with a clay of at least one of the families selected from smectites, sepiolites, vermiculites and illites; and
adding at least one anionic or cationic flocculating agent, followed by precipitation and separation so as to recover the aqueous solution.

Settling out is advantageously carried out between the precipitation and the separation. The separation consists in removing the supernatant in order to eliminate the precipitate (i.e. the sludge). This removal of the supernatant can be optionally supplemented with a filtration of the supernatant in order to eliminate any trace of precipitate. The sludge may, for its part, be centrifuged so as to recover more supernatant.

The inventors have demonstrated, entirely unexpectedly, that the solutions recycled several times are more effective for washing the industrial equipment than those which have been regenerated only once. In other words, the more the solution is regenerated, the more effective it is both in terms of its detergent action and in terms of its antibacterial action.

The use of a solution recycled several times is equivalent to a solution regenerated a first time, to which surfactants are added. Consequently, working with a recycled solution is advantageous for several reasons, in particular because this solution, which is no longer simple scrap, but a solution that is even more effective than the starting cleaning solution, is exploited. Furthermore, for cases where the cleaning must be carried out under more drastic conditions, it is not necessary to add to the solution synthetic chemical agents of the synthetic surfactant type, given that the several-times-recycled solution already demonstrates an equivalent effectiveness in this regard and without the drawbacks associated with untimely foaming.

The expectations of the green chemistry field are thus met, with recycling of the waste and a decrease in the overall impact on the environment. Finally, having a more effective solution makes it possible to envision shorter cleaning cycles, thereby making it possible to improve the yield and to reduce the wearing of the equipment that is brought about during the contacting with the acid and/or basic cleaning solutions.

For the purposes of the present invention, a cleaning solution consists of a solution which demonstrates a detergent and/or disinfectant activity.

Complete cleaning also corresponds to a satisfactory disinfection whatever the starting bacterial level of the equipment treated. A complete cleaning consists of an elimination of at least 99.9%, preferably 99.99%, of the bacteria present in the pipework, or even the open chambers, of the equipment to be treated. Ideally, a complete cleaning corresponds to the elimination of 100% of the bacteria. The method for measuring the amount of bacteria that is used here is described in detail later in the description.

The pipework, or even the open chambers, of the equipment are preferably strictly speaking piping and chambers (reactors, balloon flasks, etc.) which are metal, preferably made of stainless steel. It may also be a question of glass pipework for very specific applications.

The organic deposits are preferably food deposits; they are advantageously production residues deposited in dairy equipment. Deposits of the textile or cosmetics industry may also be cleaned.

The clay treatment level in the solution is from 1 to 5 kg/m³ of solution to be regenerated, preferably 2.5 and 3.5 kg/m³, and the flocculant treatment level is from 1 to 40 g/m³. The flocculant treatment level is advantageously from 10 to 30 g/m³, or even from 15 to 25 g/m³.

A treatment level of from 1 to 5 kg per m³ of solution to be regenerated means that the clay is either added in powder form, or already in solution, so as to obtain a concentration of from 1 to 5 kg/m³ in the solution to be regenerated thus treated.

Preferably, the ionic strength of the medium is greater than 10⁻² M, it is preferably greater than 8×10⁻² M. The ionic strength of the solution is advantageously controlled by adding NaCl to the solution to be treated. In certain cases, the ionic strength can be adjusted so as to further eliminate organic matter.

Advantageously, the clay is dissolved in a first mixture (optionally comprising CaCO₃, in particular for sodium bentonites), then it is added to the solution to be recycled; next, another aqueous solution in which at least one of the flocculating agents is dispersed is separately prepared, and this solution is in turn added to the solution to be recycled.

The temperature for heating the solution with a view to cleaning the pipework is advantageously from 60 to 100° C., or even from 70 to 90° C.

Preferably, the solution used for obtaining the cleaning solution according to the invention has undergone at least five cleaning and recycling cycles. The surface tension of the cleaning solutions is optimized starting from five regeneration cycles. Indeed, it is observed that, between one and five cycles, the surface tension decreases and reaches a minimum (stationary phase). This makes it possible to produce a solution of quality equivalent to that supplemented with a detergent, without having the drawbacks thereof, inter alia foaming. The aqueous solution used for obtaining the cleaning solution according to the invention has advantageously undergone as least ten cleaning and recycling cycles, or even fifteen cleaning and recycling cycles.

Preferably, the aqueous solution used for obtaining the cleaning solution according to the invention has undergone at least twenty cleaning and recycling cycles. The detergent power increases as the number of regenerations increases, and, in particular, starting from twenty regenerations, a greater propensity of the regenerated solution to decrease turbidity is observed.

Preferably, the pH of the aqueous solution is less than 2.5 or greater than 13. The acid or basic solutions used for cleaning food-processing equipment are more effective in these pH value ranges.

The clay which is used during the regeneration of these solutions from which the cleaning solutions according to the invention are derived is preferably of the smectite family and it is advantageously a montmorillonite.

The crystal structure of montmorillonite is based on that of pyrophyllite [Si₄Al₂O₁₀(OH)₂], which, owing to isomorphic substitutions in the aluminum oxide layer, becomes [Si₄O₁₀Al³⁺₍₂₋ₓ₎Mg²⁺ₓ(OH)₂]. Likewise, the metal atoms of the octahedral layer can be replaced with ions of lower valences. This results in a charge deficit, compensated for by the presence, between the sheets, of “compensating” cations (Li⁺, Na⁺, Ca²⁺, K⁺, Mg²⁺) which make it possible to counterbalance the negative charge of the sheets.

Montmorillonite stands out by virtue of specific properties: a high cation exchange capacity, a strong adsorbing power, a large specific surface area and swelling in an aqueous medium, which allows its use in various applications, for instance the adsorption of organic pollutants or else as an essential element in the composition of plastics, of electrical materials and of catalysts.

Preferably, the clay used is advantageously a sodium bentonite of the montmorillonite family.

Preferably, a single anionic or cationic flocculating agent is used, and this flocculating agent has a high molecular weight, i.e. greater than 10⁶ daltons, and has an ionic charge greater than 80%, or even 90%. The flocculating agent advantageously has a molecular weight greater than 3×10⁶ daltons, or even 5×10⁶ daltons.

The anionic flocculating agent is advantageously an anionic polymeric flocculant chosen from the group comprising alginic acid, alginates, sodium alginate, sodium polyacrylate, maleic copolymers, partially hydrolyzed polyacrylamides, poly anionic acids and their salts, a simple oligomer metal salt of acrylic acid, the alkali metal salt of a simple oligomer of methacrylic acid, an alkali metal salt of a complex oligomer of acrylic acid, an alkali metal salt of a complex oligomer of methacrylic acid, a low-viscosity carboxymethylcellulose and an oligomeric sulfonate. Chitosan may be used in the neutral or acid solutions.

The cationic flocculating agent may be a polyamide or a polyacrylate.

According to yet another aspect, the present invention relates to a process for cleaning industrial infrastructures using an acid or basic cleaning solution as seen in the context of the invention, formed at least partly (or even entirely, if the regeneration equipment is considered to be an integral part of the industrial equipment to be treated) in situ during the cleaning of these infrastructures. The solution having undergone at least one cleaning cycle in the equipment to be treated is then regenerated in regeneration equipment branched off the pipework to be treated.

Such a process is particularly advantageous due to the fact that it makes it possible to reduce the amount of chemical products, water and of energy required for the preparation of the cleaning solutions. This is because the solutions are regenerated and can be used for several cycles without the need to change them. The analyses carried out on the acid or basic regenerated solution quality have shown that the cleaning quality of these solutions is always preserved, or even improved, thereby excluding any limitation on the number of regenerations.

Furthermore, the regeneration of the cleaning solutions makes it possible to modify the washing sequences. Thus, the step of the first rinsing with water is deleted to be replaced with the passing of a detergent solution that will be regenerated, thereby resulting in a considerable saving in rinsing water. Regenerating all the cleaning solutions also makes it possible to capture the pollution at the source and thus to considerably reduce the volumes of waste. Finally, this makes it possible to save energy, since the heat required to maintain the solutions at more than 60° C. is predominantly recovered during the regeneration.

Such a cleaning process is advantageously used for washing dairy equipment composed of stainless steel pipework.

The use may also be extended to the treatment of any type of (industrial) food-processing equipment comprising organic deposits or inorganic deposits (scale, for example) and bacterial deposits that it is desired to clean. The organic deposits are advantageously amino acids or fatty acids and residues thereof after acid or basic treatment.

The present invention will be understood more clearly on reading the experimental section which follows, the examples and figures of which are given only by way of illustration and cannot in any way be considered to be limiting.

### BRIEF DESCRIPTION OF THE DRAWINGS

The following detailed descriptions, given by way of example, and not intended to limit the present invention solely thereto, will be best be understood in conjunction with the accompanying figures:

FIGS. 1-4 are graph of change in turbidity of the washing solution as a function of the concentration of the coagulant;

FIG. 5 is a graph of the change in turbidity of the sodium hydroxide solutions as a function of the clay concentration;

FIGS. 6-8 are graphs of the turbidity of two solutions regenerated 10 times, 15 times and 20 times, respectively;

FIG. 9 is a graph of the results of cleaning power improvement in accordance with an embodiment of the claimed invention; and

FIG. 10 is a graph of amount of solute adsorbed per gram of adsorbent as a function of the concentration at equilibrium of the casein in solution.

### DETAILED DESCRIPTION OF THE EMBODIMENTS

### Experimental Section

### I) Coagulation and Flocculation Tests:

The mechanisms of purification and entrainment of soluble or insoluble organic and inorganic matter following the coagulating action of the clays under extreme pH conditions are studied.

### Materials and Methods:

An alkaline cleaning solution model was chosen for carrying out the successive regeneration tests. The objective was to control the composition of these solutions and to be able to identify the variations in its characteristics (titer, surface tension, etc.).

For the regeneration tests, a 2% sodium hydroxide solution was prepared from technical sodium hydroxide (99% purity) and mains water, to which UHT whole milk was added in an amount of 10 g·l⁻¹.

In the context of the invention, the equipment used for measuring the turbidity is a turbidimeter, the model 2100IS (ISO 7072) sold by the company Hach®. The turbidity characterizes the cloudiness of a solution. It is expressed in NTU (nephelometric turbidity unit). The protocol used here is described hereinafter:

### Test Tube Method (Turbidity Measurement):

In order to determine the optimum concentration of clays making it possible to adsorb and coagulate the maximum pollution in a sodium hydroxide solution, several tests were carried out according to the method described by G. Lagaly, S. Ziesmer (Colloid chemistry of clay minerals: the coagulation of montmorillonite dispersions, Advances in Colloid and Interface Science. 100-102 (2003) 105-128). This method, called test tube method, consists in measuring the turbidity of a suspension of clay in various solvents and at various salt concentrations in order to determine the optimum concentration for coagulation.

In the case of the regeneration process, the method was modified so as to be able to determine the concentration of clay making it possible to purify a sodium hydroxide solution soiled with whole milk.

A sodium bentonite is of the dilutive type, preferably the Wyoming or Black Hills type; it is used to carry out the regeneration tests. It is a natural clay which has undergone no modification or specific treatment, and it is characterized by a high adsorption and coagulation capacity in acid or alkaline medium.

Alternatively, it is possible to use the following clay with conditioning:

Natural sodium bentonite is used (Na-Bentonite Premium Gel, Cetco France). Sieving was carried out in order to have a particle size of between 40 and 80 μm; this makes it possible to homogenize the suspensions of clay used for the adsorption tests. The bentonite suspension is prepared by dispersing one gram of clay prepared as described previously in 100 ml of demineralized water, and the suspension is passed to a sonicator in order to disperse the clay aggregates which may form during the dispersion. The stock solution of Na-bentonite (10 g/l) is used to have a desired clay concentration during the adsorption tests (0.1 g/l).

For the alkaline solution used here (2% NaOH, 10 g.l⁻¹ UHT whole milk), a flocculant, cationic polyacrylamide, of high molecular weight (EM 949 CT from NSF Floerger) was chosen for the treatment.

The clay concentration range is from 1 to 5 kg/m³ (in steps of 0.5) of solution to be regenerated, and the concentration of the flocculant is from 1 to 25 g/m³ (see the various examples). The reaction time is set at 3 minutes for each reagent (clay then flocculant) and the system is stirred at 200 revolutions per minute during this mixing phase. After 10 minutes of settling out, the turbidity (expressed in NTU (Nephelometric Turbidity Unit)) of the supernatant is measured, which makes it possible to set the optimum concentration for coagulation. The tests were carried out by fixing the concentration of the flocculant and varying that of the coagulant. Each measurement is repeated three times in order to verify that there is good repeatability of the tests.

### Results:

The change in the turbidity as a function of the concentration of the coagulant and of the flocculant is given in the following graphs, with the turbidity NTU (Nephelometric Turbidity Unit) along the y-axis, as a function of the amount of coagulant in kg/m³, reported on the x-axis, for four different concentrations of flocculant:

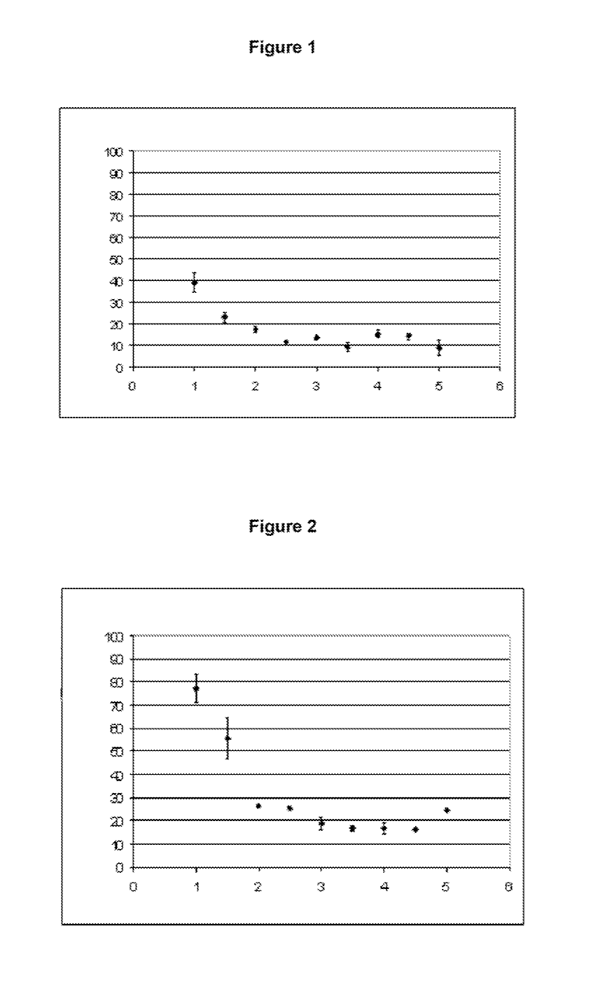

FIG. 1: 1 g/m³ of flocculant

FIG. 2: 5 g/m³ of flocculant

FIG. 3: 10 g/m³ of flocculant

FIG. 4: 15 g/m³ of flocculant.

Represented on the four Figures (FIGS. 1 to 4) is the change in turbidity (along the y-axis) of the washing solution as a function of the concentration, given in kg/m³, of the coagulant (clay: sodium bentonite used of the dilative type), this being for four concentrations of flocculant (of the cationic polyacrylamide having a concentration equal to 1, 5, 10 and 15 g/m³).

The Figures show a rapid decrease in the turbidity of the solutions for clay concentrations of between 1.5 and 3 kg/m³, before it increases again or else stabilizes. This tendency is found with the four fixed concentrations of flocculant.

The results obtained make it possible to delimit a concentration range of clay to be used of between 1.5 and 3 kg/m³. For the concentration of flocculant, the role of which is to facilitate and accelerate the settling out of the aggregates, the measurement of the turbidity of the supernatant does not constitute a determining criterion in this case, given the small volumes of solution used for the tests and the relatively long settling out time (10 minutes).

Additional tests carried out using jar tests make it possible to verify the results obtained at low volume, but also to define the optimum concentration of flocculant.

### Jar Tests

With larger test volumes, the jar-test flocculation makes it possible to determine the optimum conditions for coagulation. The optimum concentration of coagulant and of flocculant used during the process was determined with the same operating conditions as those of the previous tests (composition of the solution, treatment temperature and time). In addition, measurements of the turbidity of the supernatant, the appearance of the floc formed and the rate of settling out are taken into account for determining the best treatment conditions.

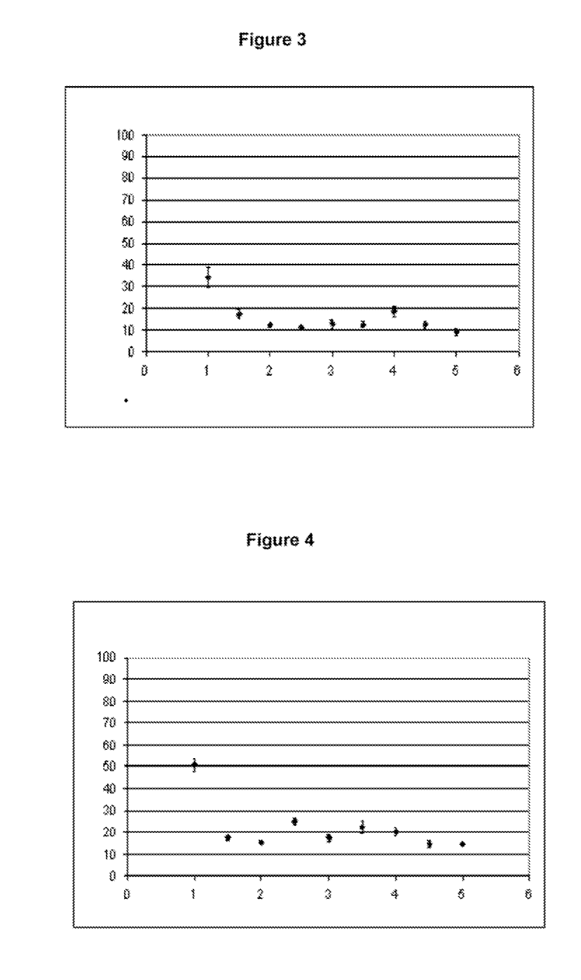

Represented on FIG. 5 is the change in the turbidity (NTU) of the sodium hydroxide solutions as a function of the concentration of clay (between 1.5 and 3 kg/m³ in steps of 0.5) and of flocculant (floc.—indicated on FIG. 5).

The measurement of the turbidity of the supernatant gives very close values, between 3 and 17 NTU, compared with a starting turbidity (soiled solution) of 600 NTU. Nevertheless, stabilization of the turbidity is noted for clay concentrations of between 2.5 and 3 kg/m³ for all the values of flocculant tested.

According to the results obtained with the test tube method and jar test method, the optimum concentration of clay to be used for the jar-test and laboratory pilot study of the process is 3 kg/m³. The flocculant concentration chosen is 20 g/m³. Such a flocculant concentration is chosen since it is optimal given its rate of settling out.

### II) Recycling of an Artificially Aged Sodium Hydroxide Solution:

The same 2% of sodium hydroxide solution, prepared from technical sodium hydroxide (99% purity) and mains water, is used for the successive regeneration tests. The UHT whole milk was added at a concentration of 10 g.l⁻¹ after each regeneration cycle in order to simulate the aging process.

The sodium hydroxide solution is heated to 80° C., at which temperature the milk is added with stirring in order to homogenize the mixture. This temperature is maintained for 15 minutes for the purpose of reproducing the same cycle of aging of the industrial solution during a standard cleaning process.

After 15 minutes, the heating is stopped and the solution is cooled to 60° C., which corresponds to the regeneration temperature.

The coagulant and the flocculant used are as defined below, in the amounts indicated relative to the solution to be regenerated:
1.5 kg/m³ of coagulant, sodium bentonite.

The sodium bentonite used is of the dilative type, preferably of the Wyoming or Black Hills type. These bentonites consist essentially of montmorillonite particles which dilate or swell strongly on contact with water.
20 g/m³ of cationic polyacrylamide flocculant, of high molecular weight, sold by the company SNF Floerger®, under the reference EM 49 CT (cationic polyacrylamide having a molecular weight of 6×10⁶ daltons and having a cationic charge of 100%), were chosen for the treatment. This is the concentration chosen to increase the size of the aggregates and to allow faster settling out.

The reagents (coagulant and flocculant) are prepared by dilution in water at 5% (w/v), i.e. 50 g/I, for the coagulant, and 0.5% (w/v), i.e. 5 g/I, for the flocculant, in order to facilitate the assaying and to improve their dispersion in the solution to be treated.

The aging equipment—regeneration of the washing solutions—is composed of:
1. a stainless steel tank heated by means of an electrical resistance and stirred by means of a propeller stirrer;
2. two beakers, one containing the coagulant to be poured into the stainless steel tank; and the other containing the flocculant also to be poured into the stainless steel tank; the content of the two beakers is provided to be poured into the tank through a dropping funnel;
3. a conical glass decanter;
4. a laboratory centrifuge (15000 G, i.e. 10 000 revolutions/min) for separating the sludge from the regenerated solution.

At the end of the settling out phase, the temperature of the regenerated solution is between 50 and 55° C.

The time of each cycle is 1 h 30, this time corresponding to the heating and cooling times required to achieve the mixing and regenerating temperatures (80° C. and 55° C.) and to the settling out time which is 30 minutes. The sludge centrifugation time, which is 20 minutes, must be added to this.

The aging and the regeneration of the solutions takes place in a stainless steel tank 340 mm in diameter, and the stirring is provided by a propeller stirrer. The stirring speed is 200 rpm.

After each regeneration, the suspension is separated by settling out and the sludge recovered at the bottom of the decanter is centrifuged for 15 minutes at 15000 G (10 000 rpm). This makes it possible to recover, on the one hand, the supernatant that will be reintroduced into the initial sodium hydroxide solution and, on the other hand, the compact sludge with a solids content of around 21%.

The volume of the solution is measured after each regeneration, thereby making it possible to monitor the losses of solution during the treatment and the separation. 200 ml of solution are sampled after each regeneration. This sampling is used to carry out the various characterization measurements:
surface tension;
turbidity; and
pH control: it is verified that the pH remains constant.

### III) Recycling of a Sodium Hydroxide Solution on Dairy Equipment:

The concentrations of the reagents are the same as those previously seen in the context of the recycling of an artificially aged sodium hydroxide solution.

A process targeted by the present invention concerns dairy equipment cleaned (cleaning in place or CIP) using sodium hydroxide solutions. A regeneration unit consisting of a first chamber comprising a reservoir equipped with a mechanical stirrer and provided to receive the soiled sodium hydroxide resulting from the cleaning of the pipework of the dairy equipment is branched onto this dairy equipment. This chamber is connected to a flocculation reactor which receives the soiled sodium hydroxide; the reagents, i.e., on the one hand, the coagulant (the clay) and, on the other hand, the flocculant are then successively poured into the flocculation reactor. The solution thus treated is then conveyed to a chamber where settling out and filtration are carried out in order to remove the sludge. The treated solution is stored with a view to being re-conveyed into the dairy equipment in order to perform a subsequent cleaning.

IV) Monitoring of the turbidity during the cleaning of pipes fouled with crème fraîche:

The turbidity of the CIP solutions was measured in order to evaluate the cleaning kinetics for the various regenerations.

Tubes made of 304 L stainless steel were fouled beforehand with a certain amount of crème fraîche. They were placed in an oven, for 1 h 30 at 130° C., after fouling with 13 grams of crème fraîche. They were turned over every 15 minutes in order to uniformly distribute the crème fraîche and were reintroduced a second time into the oven at 100° C. for 20 minutes.

These pipes were then placed in the CIP (cleaning in place) pilot so as to be cleaned with the fresh sodium hydroxide solutions (previously described in the context of part II) of the present experimental section) and regenerated at 2%. The tests were carried out at a temperature of approximately 50° C.-55° C. for 30 minutes with a flow rate of 1.5 m³/h.

The cleaning kinetics were studied via the monitoring of the turbidity of the CIP solutions over time during the cleaning of the steel tubes. The cleaning operation is carried out dynamically with a flow rate of 1.5 m³/h for 30 minutes for each cycle. The same coagulant and the same flocculant are used, under the same conditions as those described in part II) of the present experimental section.

The cleaning temperature was set at 55° C. for all the tests, thereby making it possible to compare the cleaning kinetics of the regenerated solutions and of the fresh sodium hydroxide solutions.

In order to have reliable and easily interpretable measurements, this part is carried out on a reduced volume of solutions with the aim of concentrating the matter pulled off as much as possible. The conditions for preparing the fouled pipes and the cleaning conditions make it possible to perfectly clean the surfaces. Indeed, tests carried out with the various solutions show that the surfaces are cleaned after 10 min of cleaning under the same conditions. For each regenerated solution test, a fresh solution is tested in order to be able to compare results obtained under the same conditions.

The monitoring of the kinetics of detachment of the matter was carried out with turbidity measurements. This method of characterization was chosen because it provides information on the amount pulled off as a function of time, but also on the solubilizing power of the various solutions as a function of their compositions. This is possible given that fat is soluble in a sodium hydroxide solution.

The turbidity of the solutions (expressed in NTU) is monitored by taking samples every minute from the solutions used and the reading was carried out with a Hach® 2100 IS turbidimeter (ISO 7072).

### Results:

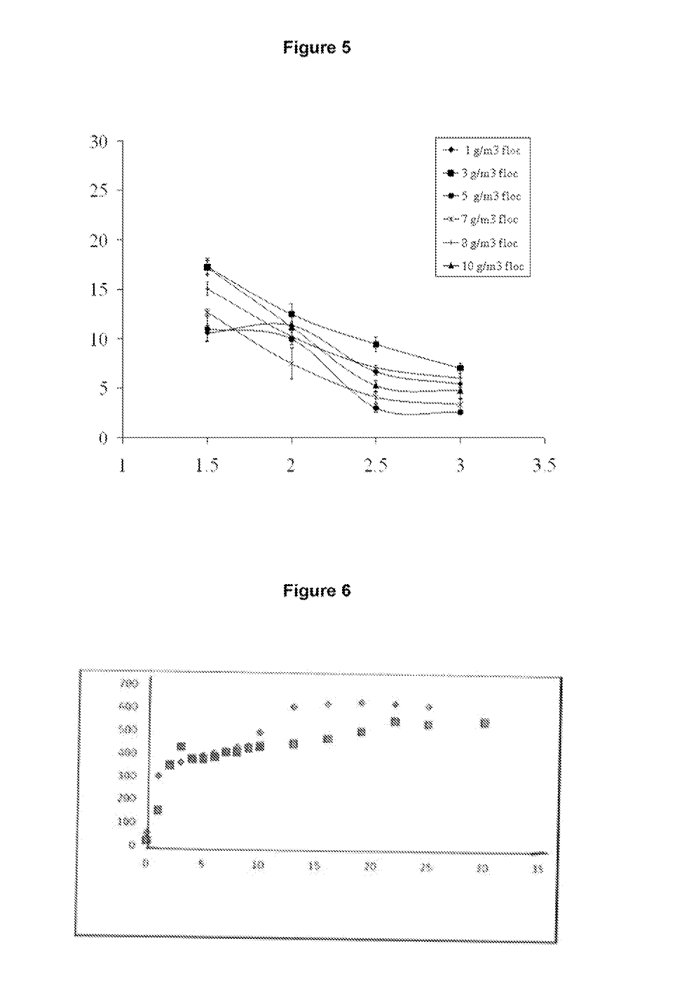

FIGS. 6 to 8 show the monitoring of the turbidity of two solutions which are a fresh sodium hydroxide solution (diamonds) and a solution of sodium hydroxide regenerated (squares) respectively 10 times (FIG. 6), 15 times (FIG. 7) and 20 times (FIG. 8). The turbidity, given in NTU units, is shown as a function of the time in minutes which appears on the x-axis.

Observation of the various curves makes it possible to emphasize the presence of 3 phases during this cleaning operation:
a first phase which corresponds to an arrangement of the surface condition by the detachment of the matter weakly fouling the surface. During this phase, which lasts 2 to 3 minutes, the flow tends to stabilize, which explains this variation in the turbidity between the tests;
a second phase which corresponds to the increase in the turbidity in the various solutions. This phase lasts about 10 minutes and makes it possible to pull off any matter adhering to the surfaces;
the third phase corresponds to the solubilization of the matter pulled off in the cleaning solutions. This solubilization is carried out under the action of the stirring caused by the pumping energy; the temperature also has the capacity to solubilize the various solutions depending on their compositions.

The results obtained show a greater detergent power of the regenerated solutions and this power increases as the number of regenerations increases. This power manifests itself through the solubilization of the organic matter pulled off, thereby explaining the drop in turbidity at the end of cleaning.

### V) Surface Tension—Cleaning Power Improvement Index:

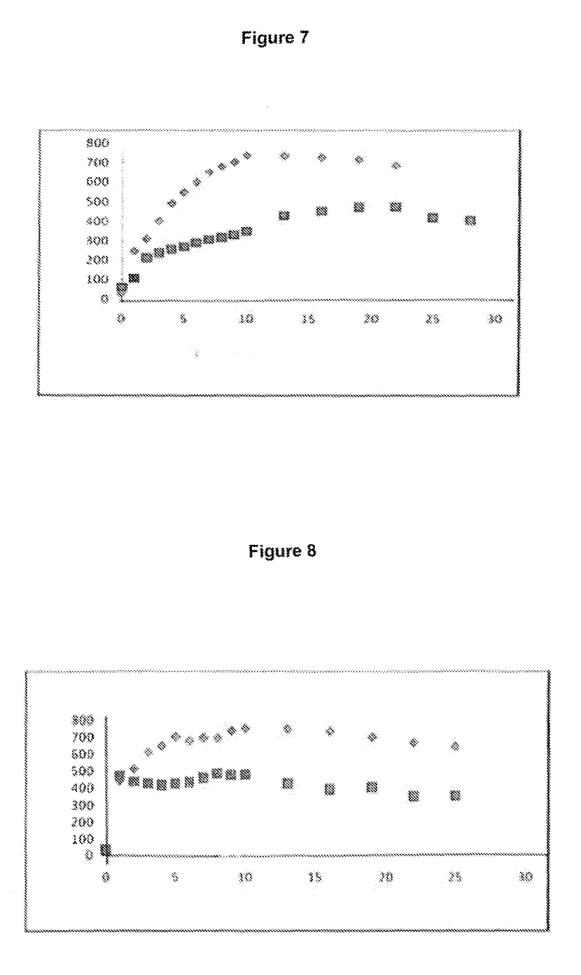

The results obtained are illustrated in FIG. 9, which represents:
along the y-axis, left-hand scale, the surface tension in mN·m⁻¹, which is of use for reading the surface tension curve (diamonds);
along the y-axis, right-hand scale, the turbidity in NTU, which is of use for reading the turbidity curve (squares); and
along the x-axis, the number of cycles.

It is observed that the treatment of the alkaline or acid solutions allows an improvement in the detergent power of these solutions as the number of regenerations increases.

This is because the alkaline or acid hydrolysis of certain constituents of the organic matter pulled off during the cleaning (more particularly the amino acids and the fatty acids) produces surfactant components responsible for lowering the surface tension of the solution, thereby improving its cleaning properties.

Surface cleanability tests (the conditions described previously in the context of part II) are used) showed that the solutions regenerated, via the adsorption—coagulation—flocculation process, allowed better wettability of the surfaces, thereby explaining the improvements observed in the cleaning of the various types of organic and inorganic fouling.

The action of these solutions in the inhibition of microbial cells is of great interest both for the vegetative form and for the sporulated form, this being in comparison with a freshly prepared sodium hydroxide solution.

For a sodium hydroxide solution, it has been observed that, during the various regeneration cycles, the surface tension continues to decrease until it reaches a limiting value of 37 mN/m (see FIG. 9). Starting from this value, the excess surfactant produced is directly removed during the regeneration, which shows that the regenerated solution may be used several times in the cleaning of equipment without it experiencing a change in property. A correction of the titer of the solution is however necessary, since, at each regeneration cycle, a decrease of 5% is observed. This correction allows complete renewal of the initial solution after 20 regeneration cycles, thereby making it possible to presume an infinite number of re-uses of the same solution

### VI) Ionic Strength Study:

Just the effect of the coagulant (without the flocculant) is studied.

The choice opted for milk proteins, more particularly casein which represents a predominant protein in the CIP solutions of dairy industries.

The casein used in this study is a 99% alkali-soluble casein (Merck KGaA, France). The casein solutions are used on the day they are prepared. The casein is first dissolved at 10 g/I in a solution at pH 12 with stirring at 200 revolutions/min for 2 hours. The pH of the solution is then adjusted to the desired pH using a 0.5 M HCl or NaOH solution. This solution is used to prepare the clay-protein mixtures during the adsorption tests.

For the tests carried out at various pHs, the solutions are prepared by adding HCl and NaOH at 0.5 M.

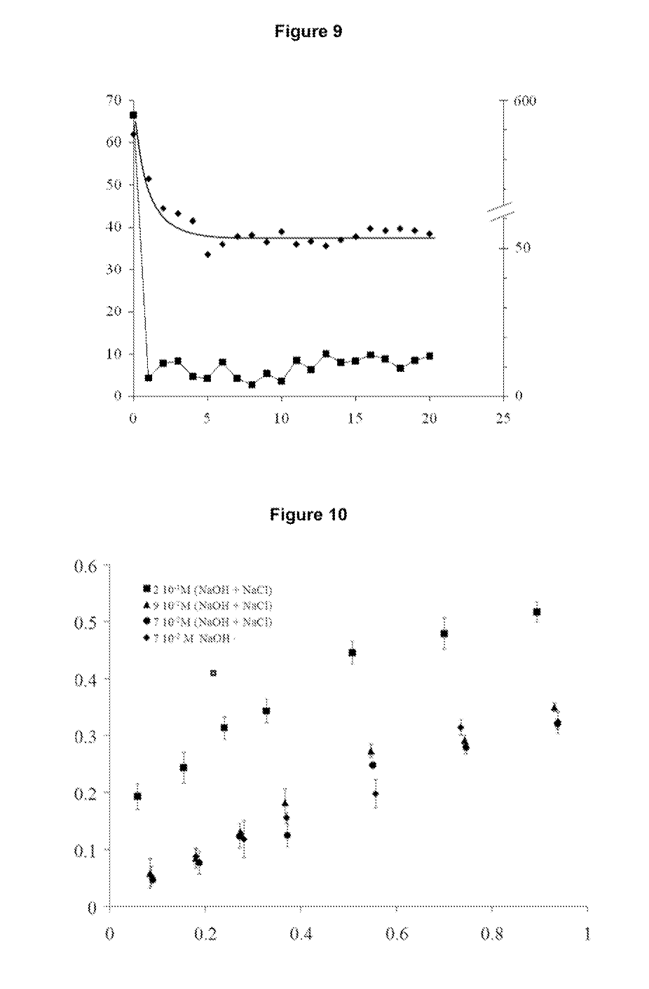

FIG. 10 shows an increase in the adsorption of casein on bentonite with the addition of NaCl, this being for a pH of 12.

FIG. 10 shows the amount of solute adsorbed per gram of adsorbent (i.e. of sodium bentonite of dilative type) (Amt in g/g) as a function of the concentration at equilibrium of the casein in solution (Ce in g/l). It shows an increase in the amount of casein adsorbed for an NaCl concentration of 10⁻¹ M. The other concentrations did not show any significant differences compared with the adsorption without the addition of salt. The adsorption curves, without addition of salt and with a salt concentration of 10⁻¹ M (FIG. 10), show a constant difference in the amounts adsorbed (improve the amount removed by 54% on average).

### VII) Measurement of the Bacterial Level:

The method used involves making a cast of the surfaces using an agar containing a colored indicator. This indicator may be BCP (bromocresol purple) which turns from violet to yellow under the effect of bacterial acid production. The strength of the yellow color is then compared with a colored scale. The other colored indicator is TTC (tetrazolium chloride) which is reduced by bacterial respiration to formazan, an insoluble compound which accumulates in the cells. The colonies then appear bright red.

During this study, the method of making a cast with agar containing TTC was used to characterize the residual contamination of the surfaces after cleaning.

Two Bacterial Strains were Monitored:
Escherichia coli

The Escherichia coli strain is a Gram-negative bacterium, it has an optimal growth temperature of 37° C. and presents in the form of smooth, convex, round white (or blue on TBX medium) colonies of medium size.

Bacillus subtilis Spores

The Bacillus subtilis strain is a Gram-positive bacillus capable of sporulating. A count is performed in order to determine the spore concentration in each tube. The results found comply with expectations with a population of 109 spores/ml.

B. subtilis has an optimal growth temperature of 30° C. and presents in the form of large white, flat, dentate colonies.

Microscopic observations are carried out using Gram staining.

### Adhesion in Stainless Steel Tubes

The objective of this experiment is still to observe the microbiological effectiveness of a cleaning solution. The tubes are fouled under the conditions described in point IV) of the present experimental section. For practical reasons of making a cast and removing the agar after it has set solid, the microbiological analyses were carried out on approximately half the internal surface, i.e. 48.38 cm².

The tubes are then immersed in the sodium hydroxide solution with substantially the same cleaning conditions as previously seen in point IV) of the present experimental section.

Indeed, after the contamination phase, the tubes were placed on the CIP pilot. The cleaning is carried out for 30 minutes with a freshly prepared or regenerated 2% sodium hydroxide solution. The temperature of the sodium hydroxide used in the tank of the pilot is approximately 80° C., but the circulation creates a loss of heat which gives a temperature in the circuits of 50 to 55° C. The flow rate is set at around 1.5 m³/h. After 30 minutes of cleaning with sodium hydroxide, rinsing with water is carried out under cold conditions for 3 minutes at a low flow rate (0.6-0.8 m³/h). This makes it possible to neutralize the walls of the tubes.

After the neutralization of the walls, the cast is made according to the technique described in the following article: Husmark, J., Heldin, N. E. & Nilsson, M. (1999). N-cadherin-mediated adhesion and aberrant catenin expression in anaplastic thyroid-carcinoma cell lines. Int J Cancer, 83, 692-9. This article describes a technique which consists in filling half the pipework with molten agar, in order to make a cast of half the surface and to quantify the residual contamination after cleaning.

Before the agar has had the time to solidify, the tube is closed and laid down on its side. The contact lasts approximately 3 hours, which is the time taken for the agar to set solid. The agar is then removed from its mold and recovered on a dish which is placed in an incubator overnight. The casts thus obtained have the shape of a half-cylinder. The tubes are then decontaminated in an autoclave so as to be reused in order to perform further measurements of the bacterial level.

For the measurements on the regenerated solutions, the process is carried out identically, but with the 2% sodium hydroxide solution being replaced with the solutions resulting from the 200 ml of solution sampled in accordance with the protocol described at the end of part II). The flow rate is adjusted identically, i.e. to 1.5 m³/h.

The results obtained are reported in Table 1:

TABLE 1
Residual contamination after cleaning of the stainless steel pipework
and monitoring of the quality of the cleaning solution (CFU/ml). Analyses
carried out with Escherichia coli bacteria.

| Regeneration | Mean | % amount of | Quality |
|---|---|---|---|
| number | CFU/agar | bacteria eliminated | CFU/ml |
| 0 | 0 | 100 | — |
| 5 | 0 | 100 | — |
| 10 | 0 | 100 | 0 |
| 15 | 0 | 100 | — |
| 20 | 0 | 100 | — |

As previously seen, during the regenerations, samples were taken from the sodium hydroxide solutions. The sample taken is, subsequently, neutralized with a hydrochloric acid solution (5 M). It is then plated out on an agar and incubated for 24 h at 37° C. or 30° C. depending on the type of microorganism being sought.

The CFU (Colony-Forming Unit) is also used for the bacterial count using cultures on dishes from tubes prepared by cascade dilutions of the stock bacterial suspension.

Macroscopic observation of the appearance of the colonies makes it possible to identify the colonies of bacteria that it is sought to isolate.

1-10. (canceled)

11. A cleaning solution obtained from an aqueous solution of alkaline or acid pH which has undergone at least two cleaning and recycling cycles, each cleaning and recycling cycle comprising the successive steps of:
heating the aqueous solution of alkaline or acid pH to a temperature above 50° C.;
cleaning a pipework of equipment fouled with organic deposits using the heated solution;
bringing the solution obtained after the cleaning step into contact with a clay of at least one of the families selected from smectites, sepiolites, vermiculites and illites; and
adding at least one anionic or cationic flocculating agent, followed by precipitation and separation to recover the aqueous solution.

12. The cleaning solution as claimed in claim 11, wherein a concentration of the clay is 1 to 5 kg/m³ of solution to be regenerated,

13. The cleaning solution as claimed in claim 12, wherein the concentration of the clay is 2.5 to 3.5 kg/m³, and a concentration of a flocculant is 1 to 40 g/m³.

14. The cleaning solution as claimed in claim 11, wherein the aqueous solution has undergone at least five cleaning and recycling cycles.

15. The cleaning solution as claimed in claim 11, wherein the aqueous solution has undergone at least twenty cleaning and recycling cycles.

16. The cleaning solution as claimed in claim 11, wherein a pH of the aqueous solution is less than 2.5 or greater than 13.

17. The cleaning solution as claimed in claim 11, wherein the clay is a montmorillonite of the smectite family.

18. The cleaning solution as claimed in claim 17, wherein the clay is a sodium bentonite of the montmorillonite family.

19. The cleaning solution as claimed in claim 11, wherein only one anionic or cationic flocculating agent of high molecular weight, greater than 10⁶ daltons, and having an ionic charge greater than 80% is used.

20. The cleaning solution as claimed in claim 11, wherein only one anionic or cationic flocculating agent of high molecular weight, greater than 10⁶ daltons, and having an ionic charge greater than 90% is used.

21. A process for cleaning industrial infrastructures using an acid or basic cleaning solution as claimed in claim 11, wherein the cleaning solution is formed at least partly in situ during cleaning of the industrial infrastructures.

22. The cleaning process as claimed in claim 21 for cleaning dairy equipment composed of stainless steel pipework.
